(19) United States
(12) Patent Application Publication
(10) Pub. No.: US 2014/0122596 A1
(43) Pub. Date: May 1, 2014

(54) METHOD AND APPARATUS FOR PROVIDING N-SCREEN SERVICE BASED ON CLOUD COMPUTING

(71) Applicants: Young-Il KIM, Daejeon-si (KR); Yang-Jung KIM, Seoul (KR); Il-Young CHONG, Seongnam-si (KR)

(72) Inventors: Young-Il KIM, Daejeon-si (KR); Yang-Jung KIM, Seoul (KR); Il-Young CHONG, Seongnam-si (KR)

(73) Assignees: Hankuk University of Foreign Studies Research and Industry-University Cooperation Foundation, Yongin-si (KR); Electronics and Telecommunications Research Instit, Daejeon-si (KR)

(21) Appl. No.: 14/062,468

(22) Filed: Oct. 24, 2013

(30) Foreign Application Priority Data
Oct. 26, 2012 (KR) 10-2012-0119758
Nov. 28, 2012 (KR) 10-2012-0136397

(51) Int. Cl. H04L 29/08

(52) U.S. Cl. CPC H04L 67/10
USPC 709/204

(57) ABSTRACT

An apparatus and method for providing an N-screen service based on cloud computing. The existing SONF incurs load and costs when discovering, generating and maintaining services. Meanwhile, the apparatus and method provided herein enable to reduce the costs by using cloud computing capabilities, and also to provide more various services, thereby enhancing a user's service satisfaction. By using the apparatus and method, it is possible to serve an alternative to an N-screen service platform architecture, and by further adopting service capabilities of ITU-T and future network features, it is possible to improve service performances and satisfaction.

### CROSS-REFERENCE TO RELATED APPLICATIONS

This application claims priority from Korean Patent Application Nos. 10-2012-0119758, filed on Oct. 26, 2012, and 10-2012-0136397, filed on Nov. 28, 2012, in the Korean Intellectual Property Office, which are hereby incorporated by references for all purposes as if fully set forth herein.

### BACKGROUND

1. Field

The following description relates to a method and apparatus for providing an N-screen service based on cloud computing and an N-screen scenario related to service overlay network functions for service control, management and maintenance, sharing and virtualization of service resources, and easy content sharing.

2. Description of Related Art

The information disclosed in this section is only for enhancement of understanding of the background of the invention and therefore it may contain information that does not form any part of the prior art.

Passive and simple functions in conventional service provision have failed to give satisfaction to service users. Thus, service provision methods employing service overlay network functions (SONF) (ITU-T Y.Sup17 Y.2200 series-Functional model of a service overlay network framework which uses the next generation network) will actively switch the type of future services since the service overlay network functions enable service control, service creation and service maintenance for the provision of more personalized satisfactory services.

Recently, cloud computing technologies which offer additional services while reducing processing burden on a user's terminal and lowering power consumption, such as a terminal battery, through simplification of processing have been widely adopted. The cloud computing technologies provide service models, such as Infrastructure as a Service (IaaS), Platform as a Service (PaaS), and Software as a Service (SaaS). At present, a range of cloud computings are available, including private cloud computing, public cloud computing, hybrid cloud computing, and personalized cloud computing.

Therefore, there is a need for methods to link service overlay network functions and diverse cloud services to achieve enhanced user satisfaction, and a method of differentiating an N-screen service using the SONF is implemented with a scenario and a configuration.

### SUMMARY

The following description relates to structure and requirements of service overlay network functions that use cloud computing in an effort to offer optimized services and to improve user satisfaction by overcoming simplicity and passiveness of conventional services, and also relates to a basic framework for provision of dynamically optimized and personalized services. Hence, various services including private cloud computing services, public cloud computing services, hybrid cloud computing services are enabled to work together with service overlay network functions, which proposes a next-generation service structure.

In the provision of an N-screen service, there may be requests for functions related to service routing, service discovery and control and service delivery to link with various cloud services. By successively responding to these requests and creating numerous services by linking heterogeneous cloud services with the service overlay network functions, it is possible to achieve enhanced service personalization.

In one general aspect, there is provided a method of providing an N-screen service based on cloud computing, the method including: receiving, at terminal A in motion, an N-screen service from a service provider; issuing, at terminal B in motion, a request to the service provider for the N-screen service; preparing, at the service provider, the N-screen service for terminal B; providing, at the service provider, the N-screen service to terminal B using cloud computing; and continuously providing, at the service provider, the N-screen service to terminal C in motion.

In another general aspect, there is provided an apparatus for providing a service, including: a service providing unit configured to provide an N-screen service to terminal A in motion; a service request receiving unit configured to receive a request signal for the N-screen service from terminal B in motion; a service preparing unit configured to prepare the N-screen service for terminal B; a service control unit configured to provide the N-screen service to terminal B using cloud computing; and a seamless service providing unit configured to provide the N-screen service to terminal C in motion.

Other features and aspects will be apparent from the following detailed description, the drawings, and the claims.

### BRIEF DESCRIPTION OF THE DRAWINGS

FIG. 1 is a diagram illustrating a service overlay network function (SONF) system combined with cloud for N-screen service composition, according to an exemplary embodiment of the present invention.

FIG. 2 is a diagram illustrating a home service overlay network system according to an exemplary embodiment of the present invention.

FIG. 3 is a diagram illustrating process of composing an N-screen service tailored to a user by connecting to a cloud service providing unit with employing an SONF system, according to an exemplary embodiment of the present invention.

FIG. 4 is a diagram illustrating an example of a service overlay network function (SONF) system model which uses a cloud computing service to provide an N-screen service, according to an exemplary embodiment of the present invention.

FIG. 5 is a diagram illustrating a system for providing a cloud computing-based N-screen service (content sharing) according to an exemplary embodiment of the present invention.

FIG. 6 is a block diagram illustrating a service provider according to an exemplary embodiment of the present invention.

FIG. 7 is a flowchart showing a service scenario of an N-screen service that enables the continuous use of the same content on a plurality of devices through a cloud computing service according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the exemplary embodiment, a configuration of a home service-based overlay network system is provided, which enables the use of cloud service providers, and which thereby provides a system structure and method capable of generating more personalized and dynamic services.

Hereinafter, a framework for efficiently, dynamically providing services by a connection between a service overlay network function (SONF) and cloud service providers is described with reference to the accompanying drawings.

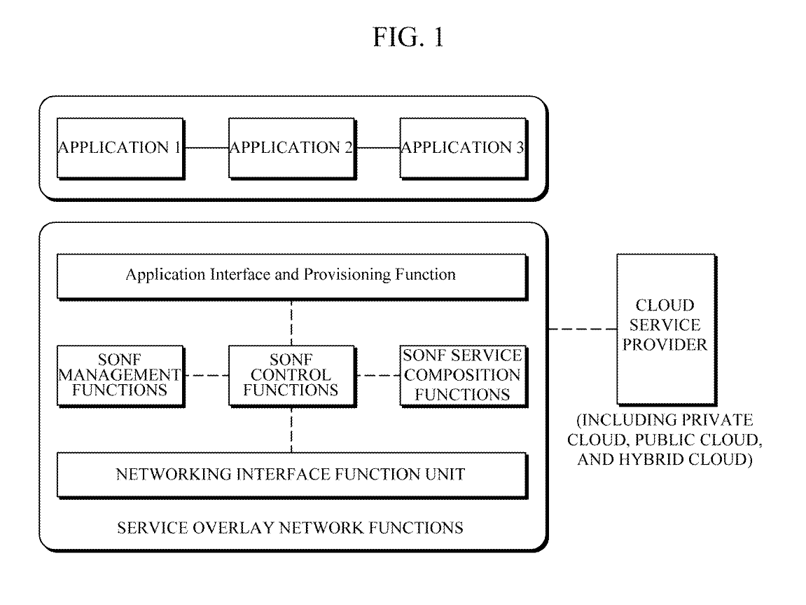

FIG. 1 illustrates a service overlay network function (SONF) system according to an exemplary embodiment of the present invention. Referring to FIG. 1, the SONF system includes an interface that is connected to a cloud service provider. The existing service overlay network functions incur load and costs when discovering, generating and maintaining services. However, according to the exemplary embodiment of the present invention, cloud computing capabilities reduce processing costs and enable service providers to offer a variety of services, thereby increasing the user's satisfaction.

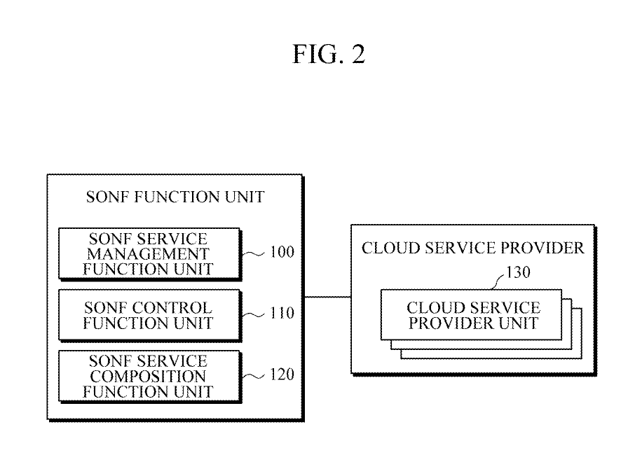

FIG. 2 is a diagram illustrating a home service overlay network system according to an exemplary embodiment of the present invention. Referring to FIG. 2, the service overlay network system includes a service overlay network function (SONF) service management function unit 100, a SONF control function unit 110, a SONF service composition function unit 120, and a cloud service provider unit 130. The SONF service management function unit 100 manages services within a service overlay network and service performances of cloud service providers. The SONF control function unit 110 has controls related to service negotiation and service management, with respect to discovered services. The SONF service composition function unit 120 configures and provides services personalized to users who have used cloud computing services served by the cloud service provider unit 130, as well as services within the service overlay network.

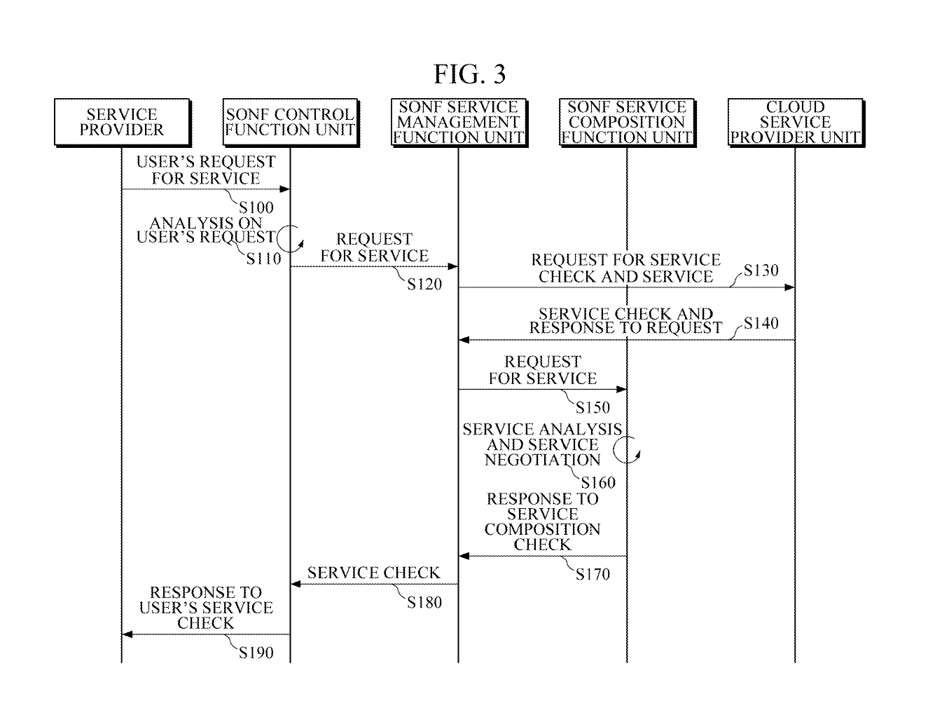

FIG. 3 is a diagram illustrating process of composing an N-screen service tailored to a user by connecting to a cloud service providing unit that employs an SONF system.

First, a service user configures services used for an N-screen service. The configuration of services is referred to as service canvas, in which services related to services requested in each screen are requested in S100. A SONF control function unit of the SONF system analyzes the request in S110. Using analysis information, the SONF control function unit delivers the service request to a SONF service management function unit in S120. The SONF service management function unit requests a cloud service provider unit to check services and provide a requested service in S130, and the cloud service provider unit responds to the request in S140. The SONF service management function unit issues a request message to a SONF service composition function unit to request for configuring and checking a service in S150, and the SONF service composition function unit re-checks the service and performs service negotiation in S170. When service negotiation is required in terms of accuracy and quality of service, the SONF service composition function unit performs the service negotiation in S160.

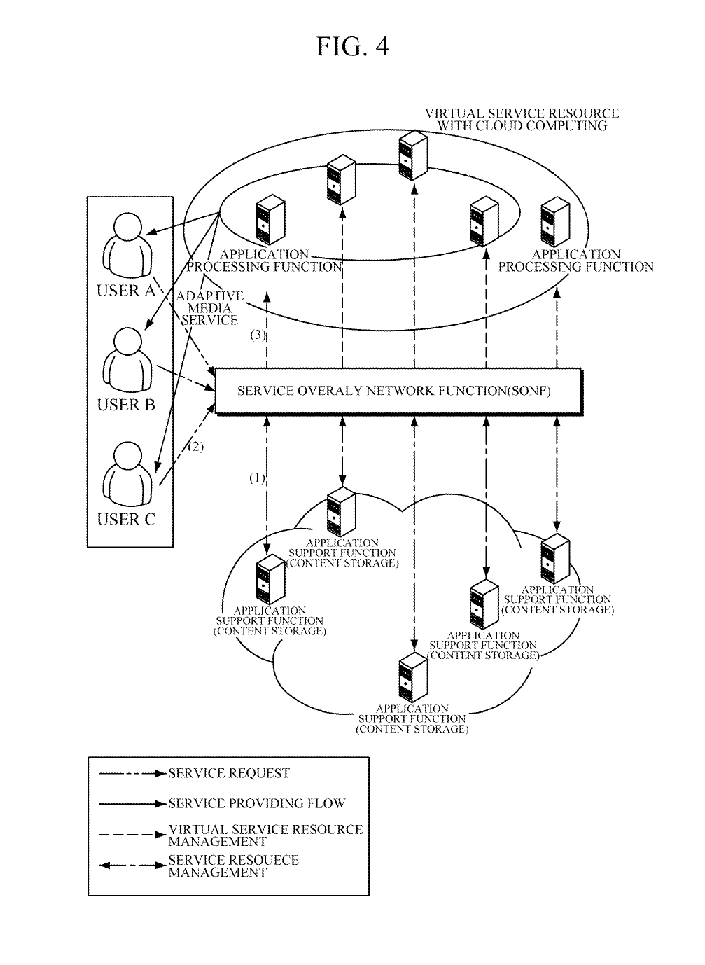

FIG. 4 is a diagram illustrating an example of a service overlay network function (SONF) system model which uses a cloud computing service to provide an N-screen service, according to an exemplary embodiment of the present invention.

A service overlay network function (SONF) shown in FIG. 4 enables a particular logic networking service to be deployed fast and easily. The fast and easy deployment of particular networking service may be used to supplement services to be provided to a delivery network. Accordingly, the SONF can support dynamic service orchestration using cloud computing services for N-screen services.

Referring to (1) in FIG. 4, the SONF combined with cloud computing capabilities manages services, such as service orchestration, for composing service Canvas, and service computing resources, such as a network, servers, storage media, applications, converting modules, and delivery. In addition, the SONF combined with cloud computing capabilities may be provided fast with interaction with a service provider or a reduced management effort. In addition, referring to (2) in FIG. 4, end users including user A, user B, and user C request the N-screen service to the service provider capable of supporting the SONF combined with cloud computing capabilities.

Referring to (3) in FIG. 4, the SONF generates a new N-screen service that uses clod computing functions, based on features of the request from each of end users, user A, user B, and user C. In addition, referring to (4) in FIG. 4, the end users, user A, user B, and user C, are enabled to view contents adjusted in consideration of a display size of each terminal in use, and to use additional services related to the content provided by the SONF using cloud computing functions.

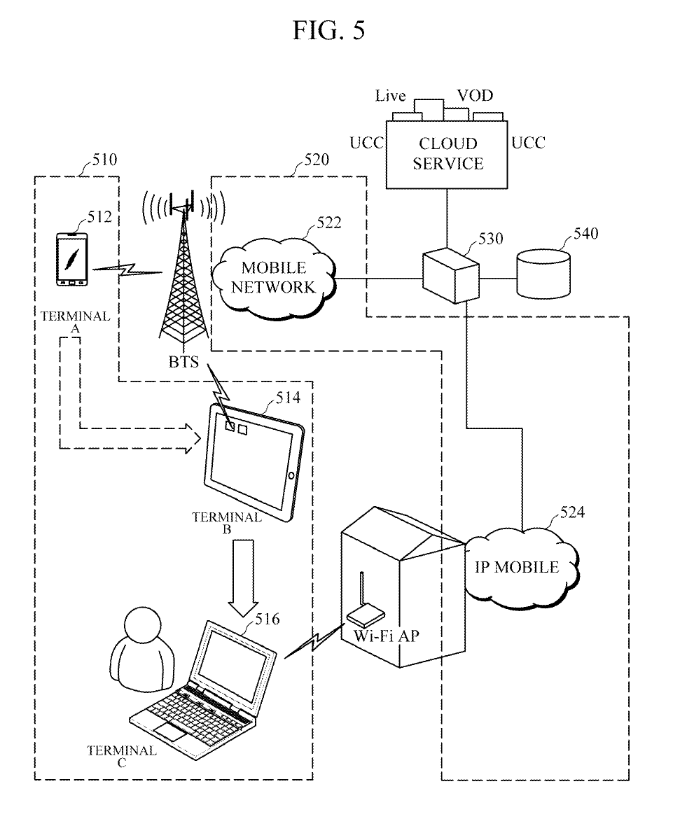

FIG. 5 is a diagram illustrating a system for providing a cloud computing-based N-screen service (content sharing) according to an exemplary embodiment of the present invention. Referring to FIG. 5, the system includes a terminal 510, a communication network 520, a service provider 530, and a content provider 540. However, aspects of the present invention are not limited thereto, such that various modifications may be made to elements included in the system for providing a cloud computing-based N-screen service within the scope of the invention.

The terminal 10 refers to a terminal that can transmit and receive various types of data via the communication network 520 in accordance with a user's manipulation of buttons on the terminal, and may be one of a tablet personal computer (PC), a laptop, a PC, a smartphone, a personal digital assistant (PDA), and a mobile communication terminal. The terminal 510 includes terminal A 512, terminal B 514, and terminal C 516. That is, the terminal 510 in FIG. 5 includes a plurality of terminals, and is not be limited only to terminal A 512, terminal B 514, and terminal C 516. In addition, the terminal 510 may be a cloud computing terminal that supports cloud computing, enabling reading, writing and storing of data and using of network or content services through a communication network.

The terminal 510 performs voice or data communications through the communication network 520, and includes memory to store programs or protocols for communication with the service provider 530 via the communication network 520, and a microprocessor to execute a relevant program for computing and control. Hence, the terminal 510 may be any types of terminal that is capable of server-client communication with the service provider 530, including all range of communication computing devices, such as a notebook computer, a mobile communication terminal, a PDA, and the like. The terminal 510 may be configured to include a touch screen, but the aspects of the invention are not limited thereto.

The terminal 510 includes an N-screen service application to reproduce content corresponding to an N-screen service. The terminal 510 may run the N-screen service application in response to a user's manipulation on the terminal or instruction, and reproduce content which is received from the service provider 530, corresponding to the N-screen service, using the N-screen service application. In the case of the terminal 510 being a smartphone, the N-screen service application may be downloaded from the application store and installed in the terminal 510, and in the case of the terminal 510 being a feature phone, the N-service application may be run on a virtual machine (VM) on which the N-screen service application is downloaded from a communication operator's server.

The N-screen service application may be implemented to be embedded in the terminal 510, or embedded in an operation system (OS) equipped in the terminal 510, or installed in the OS in the terminal 510 in response to the user's manipulation or instruction. The N-screen service application embedded or installed in the terminal 510 may be implemented to work together with default applications (e.g., video application) embedded in the terminal 510. However, the aspects of the invention are not limited thereto, such that the N-screen service application may be executed to serve an independent function without working with the default applications.

The communication network 520 refers to a network that relays data between the service provider 530 and the terminal 510. The communication network 520 includes a mobile network 520 and an Internet protocol (IP) network 524. Here, the mobile network 520 may be a base-station-based mobile communication network, and the IP network 524 may be a Wi-Fi®-based Internet. In addition, the communication network 520 may include a cloud computing network that is connected with the service provider 530 to store computing sources, such as hardware and software resources, and provide the terminal 510 with computing resources needed by a client. Here, “cloud computing” refers to a computer environment in which information is stored permanently in a server on the Internet and temporarily in a client terminal, such as a desktop, a table computer, a notebook computer, a netbook computer, a smartphone, and the like. Also, cloud computing refers to a computer access network environment in which all information related to a user is stored in a server on the Internet and various IT devices are allowed to access the stored information, at any time, anywhere.

The service provider 530 is a service providing device that provides an N-screen service to the terminal 510 via the communication network 520. The service provider 530 associated with the content provider 540 provides content received from the content provider 540 to the terminal 510 through the communication network 520. The service provider 530 that supports the cloud computing may provide the terminal 510 with the content received from the content provider 540 as a cloud computing-based service.

The service provider 530 provides an N-screen service to terminal A 512 in motion, and prepares an N-screen service for terminal B 514 in response to an N-screen service request signal from terminal B 514 in motion, then provides the N-screen service to terminal B 514 using cloud computing, and provides the N-screen service to terminal C 516 in motion.

Hereinafter, procedures for the service provider 530 to provide the N-screen service to terminal A 512 will be described. The service provider 530 provides the N-screen service to terminal A 512 using cloud computing. The service provider 530 uses content delivery functions to provide content corresponding to the N-screen service to terminal A 512. In addition, when terminal A 512 requests an additional service related to the content corresponding to the N-screen service, the service provider 530 supports or generates the additional service using the cloud computing. Further, in the case of handover to terminal A 512, the service provider 530 provides new channel access information to terminal A 512 for continuity of the N-screen service. If an error is detected in network functions of a network provider that provides the N-screen service to terminal A 512, the service provider 530 moves IT resources to another location to resolve the error. If a determination is made that the detected error has occurred due to the IT resources, the service provider 530 reassigns the IT resources as IT resources that have yet to be used for the cloud computing.

Hereinafter, procedures of the service provider 530 to receive a request signal for the N-screen service from terminal B 514 will be described. The service provider 530 receives a request signal for the same content with respect to the N-screen service from terminal B 514 in motion. Then, in response to terminal B 514 being authenticated as a subscriber terminal to the N-screen service, the service provider 530 receives the request signal for the same content with respect to the N-screen service from terminal B 514.

Hereinafter, procedures of the service provider 530 to prepare the N-screen service for terminal B 514 will be described. The service provider 530 processes the requested N-screen service using the service control functions so as to continuously display the same content on terminal B 514. Additionally, by using the service control functions, the service provider 530 controls quality of content associated with the N-screen service, according to adjustable network bandwidth, or determines whether to transcode original content for the N-screen service into content in a format suitable for a display size of another terminal to be switched to. When a determination is made that it is required for the original content for the N-screen service to be adjusted in consideration of the display size of the other terminal to be switched to, the service provider 530 may transcode the original content into content in a format suitable for the display size of the other terminal.

Hereinafter, procedures of the service provider 530 to provide the N-screen service to terminal B 514 will be described. The service provider 530 delivers new content, which is newly generated using cloud computing, to a dedicated storage unit (e.g., storage or storage medium) that is managed by content delivery functions, and delivers content with controlled quality to terminal B 514 by using the content delivery functions.

Herein, procedures of the service provider 530 to provide the N-screen service to terminal C 516 will be described. The service provider 530 delivers, to terminal C 516 in motion, the same content with respect to the cloud computing-based N-screen service using the content delivery functions.

The content provider 540 is a content providing device to provide content to the service provider 530. The content that is provided by the content provider 540 to the service provider 530 may be video content. However, the aspects of the invention are not limited thereto, such that the content may include various types of multimedia content, such as text, audio, images, video on demand (VOD), user created contents (UCC), e-mails, E-books, E-learning, and games.

Hereinafter, an example of a cloud computing service with content sharing functions, which is equivalent to an N-screen service that continuously uses the same content, will be described with reference to FIG. 5. In FIG. 5, an N-screen service providing service continuity by use of a cloud computing service is illustrated.

An N-screen service scenario in which a plurality of devices are allowed to continuously use the same content through a cloud computing service is described as below.

[Service provider 530:->End user (individual): end user (individual) currently using N-screen service with terminal A 512 through cloud computing service] The end user (individual) uses terminal A 512 (e.g., a smartphone) to view content provided by the content delivery functions of the service provider 530 with cloud computing, via the network functions of a network provider (e.g., the communication network 520). In a case where the user requests an additional service related to the current content, the service provider 530 may more efficiently support, generate or control the additional service, by use of the cloud computing service. During the handover to terminal A 512, the end user is provided with a new channel access from the service provider 530 for the service continuity. If an error occurs in network functions, IT resources may be moved to another location to resolve the error. If an error is caused due to the IT resources, the IT resources may be reassigned as IT resources that have yet to be used for the cloud computing service.

[End user (individual): end user (individual) switching N-screen service to terminal B 514] For example, the end user moves from an office to coffee shop, wanting to continuously view the same content on terminal B 514 (e.g., a pad computer or a tablet computer).

[Terminal B 514->service provider 530: service provider 530 for providing N-screen service to terminal B 514] Terminal B 514 is authenticated as a subscriber to the N-screen service, and requests the service provider 530 offering cloud computing service for the same content.

[Service provider 530: service provider 530 preparing N-screen service for terminal B 514] By using the service control functions, the service provider 530 processes the same content with respect to the N-screen service requested by terminal B 514, such that terminal B can continuously display the same content. With the assistance of a cloud computing service, the service control functions of the service provider 530 can control the content quality according to adjustable network bandwidth and determine whether to transcode original content into content in a format suitable for a display size of another terminal to be switched to.

[Service provider 530->terminal B 514->end user (individual): end user (individual) in use of N-screen service] New content that is newly generated using the cloud computing service is delivered to a particular (designated) storage medium that is managed by content delivery functions. The content delivery functions deliver the new content to terminal B 514.

[End user (individual): end user (individual) switching N-screen service to terminal C 516] The end user moves from the coffee shop to home, wanting to continuously watch the same content using terminal C 514 (e.g., a laptop PC). The same content is delivered to terminal C 516 by content delivery functions through the cloud computing service, thereby being available to the end user that is the owner of terminal C 516.

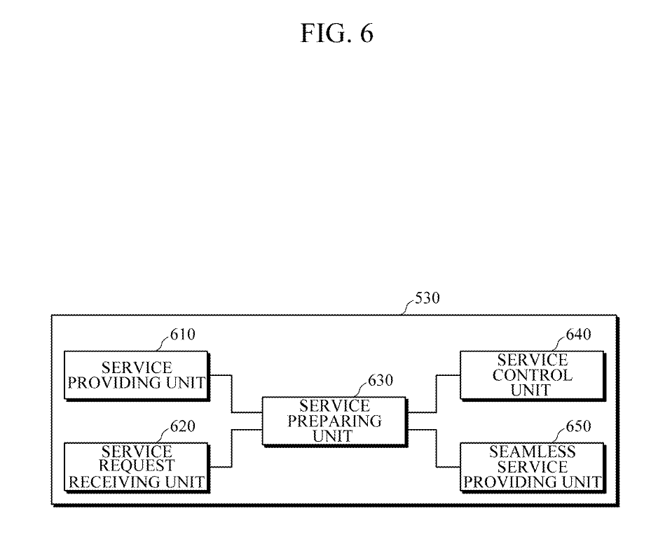

FIG. 6 is a diagram illustrating a service provider according to an exemplary embodiment of the present invention.

Referring to FIG. 6, the service provider 530 as a service providing device includes a service providing unit 610, a service request receiving unit 620, a service preparing unit 630, a service control unit 640, and a seamless service providing unit 650. However, the aspects of the invention are not limited thereto, such that various modifications may be made to elements included in the service provider 530 within the scope of the invention.

The service providing unit 640 provides an N-screen service to terminal A 512 in motion. The service providing unit 610 uses cloud computing to provide the N-screen service to terminal A 512. In this case, the service providing unit 610 provides content corresponding to the N-screen service through content delivery functions. In addition, when terminal A 512 requests additional services related to the content, the service providing unit 610 supports or generates the requested additional services using cloud computing. Further, in the case of handover to terminal A 512, the service providing unit 610 provides new channel access information to terminal A 512 for continuity of N-screen service. When an error in network functions of a network provider that provides the N-screen service to terminal A 512 is detected, the service providing unit 510 moves IT resources to another location to resolve the errors. If it is determined that the error is caused by IT resources, the service providing unit 610 reassigns the IT resources as IT resources that have yet to be used for the cloud computing.

The service request receiving unit 620 receives a request signal for the N-screen service from terminal B 514 that is in motion. The service request receiving unit 620 receives a request signal for the same content with respect to the N-screen service from terminal B 514 in motion. In response to the service provider 530 authenticating terminal B 514 as a subscriber to the N-screen service, the service request receiving unit 620 receives the request signal for the same content with respect to the N-screen service from terminal B 514.

The service preparing unit 630 prepares the N-screen service for terminal B 514. In this case, the service preparing unit 630 uses service control functions to process the N-screen service that is requested for terminal B 514 to continuously display the same content. In addition, the service preparing unit 630 controls quality of content associated with the N-screen service, according to adjustable network bandwidth, using service control functions. Further, the service preparing unit 630, with the assistance of the service control functions, determines whether to transcode original content for the N-screen service into content in a format suitable for a display size of another terminal to be switched to. When a determination is made that the original content for the N-screen service is required to be adjusted, in consideration of the display size of the other terminal to be switched to, the service preparing unit 630 may transcode the original content into content in a format suitable for the display size of the other terminal.

The service control unit 640 provides the N-screen service to terminal B 514 using cloud computing. The service control unit 640 delivers new content, which is newly generated using cloud computing, to a dedicated storage unit (e.g., storage) that is managed by content delivery functions, and delivers the content with controlled quality to terminal B 514 by using the content delivery functions.

The seamless service providing unit 650 provides the N-screen service to terminal C 516 that is in motion. Using the content delivery functions, the seamless service providing unit 650 provides the same content with respect to the N-screen service to terminal C 516 in motion, using cloud computing.

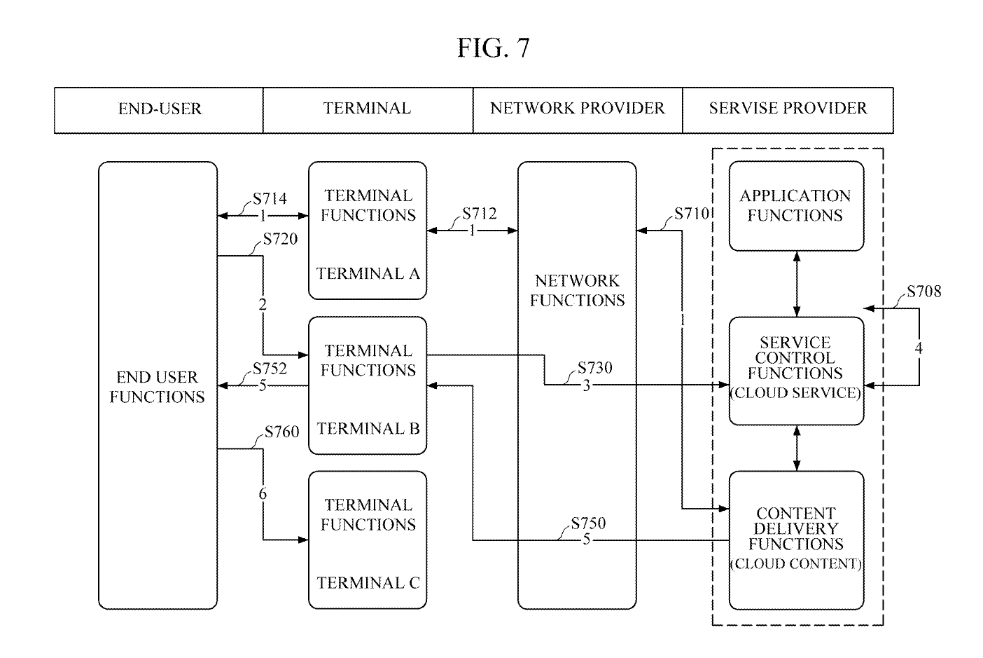

FIG. 7 is a flowchart showing a service scenario of an N-screen service that enables a continuous use of the same content on a plurality of devices through a cloud computing service.

Referring to 1 in FIG. 7, an end user using terminal A 512 issues a request for an N-screen service to a service provider 530 via a network provider (e.g., a communication network 520). The service provider 530 uses content delivery functions to deliver cloud content corresponding to the requested N-screen service to the network provider (e.g., the communication network 520) in S710. In S712, the network provider delivers the received cloud content corresponding to the N-screen service to terminal A 512, and the cloud content is delivered to the end user through terminal A 512 in S714. That is, [service provider 530->end user (individual): terminal A: an end user (individual) currently using N-screen service with terminal A 512 through cloud computing service].

In this case, the end user (individual) uses terminal A 512 (e.g., a smartphone) is viewing content provided by the content delivery functions of the service provider 530 with cloud computing service over the network functions of the network provider (e.g., a communication network 520). If the user wants additional services related to the content, the service provider 530 may support, generate and control the additional services more efficiently by using the cloud computing service.

In the case of the handover to terminal A 512, the end user is provided with new channel access from the service provider 530 for service continuity. If an error occurs in the network functions, IT resources may be moved to another location to resolve the error. If an error is caused due to the IT resources, the IT resources may be reassigned as IT resources that have yet to be used for the cloud computing service.

Referring to 2 in FIG. 2, the end user moves from a particular area to another area in S720. For example, the end user moves from the office to a coffee shop. In this case, the end user has been watching cloud content with terminal A 512 wherein the cloud content, corresponding to the N-screen service, is provided from the service provider 530, and may carry terminal B 514 when the end user moves to the coffee shop. That is, [End user (individual):

End user (individual) switching N-screen service to terminal B 514], the end user moves from the office to the coffee shop, wanting to continuously viewing the same content using terminal B 514 (e.g., a pad computer or a tablet computer).

Referring to 3 in FIG. 7, terminal B 514 transmits a request signal for the N-screen service to the service provider 530 via the network provider (e.g., the communication network 520) in S730. That is, [Terminal B 514->service provider 530: the service provider 530 for providing the N-screen service to terminal B 514] terminal B 514 is authenticated as a subscriber to the N-screen service, and requests the service provider 530 with cloud computing service to transmit the same content to terminal B 514.

Referring to 4 in FIG. 7, the service provider 530 prepares an N-screen service for terminal B 514 using the service control functions in S740. That is, [service provider 530: service provider 530 preparing N-screen service for terminal B] the N-screen service requested for terminal B 514 to continuously display the same content is processed by the service control functions of the service provider 530. By using the cloud computing services, the service provider 530 controls quality of content associated with the N-screen service, according to adjustable network bandwidth, or determines whether to transcode original content for the N-screen service into content in a format suitable for a display size of another terminal to be switched to.

Referring to 5 in FIG. 7, the service provider 530 provides the N-screen service to terminal B 514 via the network provider (e.g., the communication network 520) using the content delivery functions. Then, terminal B 514 displays the N-screen service to the end user in 752. That is, [Service provider 530->terminal B 514->end user (individual): end user (individual) using N-screen service] new content newly generated using the cloud computing service is delivered to a particular (designated) storage medium that is managed by the content delivery functions. The content delivery functions deliver the new content to terminal B 514.

Referring to 6 in FIG. 7, the end user moves from one place (e.g., a coffee shop) to home in S760. For example, when the end user is moving from the coffee shop to home while watching cloud content corresponding to the N-screen service using terminal B 514, the end user may carry terminal C 516. That is, [End user (individual): end user (individual) switching the N-screen service to terminal C 516] the end user may move from the coffee shop to home, wanting to continuously view the same content on terminal C 516 (e.g., a laptop PC). After operation S760, the service provider 530 uses the content delivery functions to deliver the same content to terminal C 516 using the cloud computing service, and thereby enabling the end user, an owner of terminal C 516, to view the same content.

Operations S710 to S760 of the flowchart in FIG. 7 are described as being sequentially performed, but the aspects of the invention are not limited thereto, such that the order of performing operations of the flowchart in FIG. 7 may be changed or one or more operations among S710 to S760 may be performed in parallel.

As described above, by allowing service overlay network functions (SONF) including service generation, maintenance, and control to be linked to cloud service providers, it is possible to reduce the burden incurred when generating more services, enable effective sharing of existing services, and increase the user's service satisfaction.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing an N-screen service based on cloud computing, the method comprising:
receiving, at terminal A in motion, an N-screen service from a service provider;
issuing, at terminal B in motion, a request to the service provider for the N-screen service;
preparing, at the service provider, the N-screen service for terminal B;
providing, at the service provider, the N-screen service to terminal B using cloud computing; and
to continuously providing, at the service provider, the N-screen service to terminal C in motion.

2. The method of claim 1, wherein the receiving of the N-screen service comprises providing, at the service provider, the N-screen service to terminal A using the cloud computing.

3. The method of claim 1, wherein the receiving of the N-screen service comprises receiving content corresponding to the N-screen service through network functions of a network provider, the N-screen service being provided by contents delivery functions of the service provider that supports the cloud computing.

4. The method of claim 3, wherein the receiving of the N-screen service comprises, in response to a request of terminal A for an additional service related to the content, supporting or providing, at the service provider, the additional service using the cloud computing.

5. The method of claim 1, wherein the receiving of the N-screen service comprises, in a case of handover from the service provider to terminal A, providing new channel access information to terminal A for continuity of the N-screen service.

6. The method of claim 3, wherein the receiving of the N-screen service comprises, in response to the service provider detecting an error in the network functions, moving IT resources to another location in an effort to resolve the error.

7. The method of claim 6, wherein the receiving of the N-screen service comprises, in response to a determination of the service provider that the error is caused due to the IT resources, reassigning the IT resources as IT resources that have yet to be used for the cloud computing.

8. The method of claim 1, wherein the issuing of the request for the N-screen service comprises issuing, at terminal B in motion, a request to the service provider for same content with respect to the N-screen service.

9. The method of claim 1, wherein the issuing of the request for the N-screen service comprises in response to the service provider authenticating terminal B as a subscriber terminal to the N-screen service, issuing, at terminal B, a request to the service provider for same content with respect to the N-screen service.

10. The method of claim 1, wherein the preparing of the N-screen service comprises processing, at the service provider, the requested N-screen service using service control functions in order to seamlessly (continuously?) display same content on terminal B.

11. The method of claim 10, wherein the preparing of the N-service comprises controlling, at the service provider, quality of the same content with respect to the N-screen service, according to adjustable network bandwidth by using the service control functions.

12. The method of claim 11, wherein the preparing of the N-service comprises determining, at the service provider, whether to transcode original content for the N-screen service into content in a format suitable for a display size of another terminal to be switched to, by using the service control functions.

13. The method of claim 1, wherein the providing of the N-screen service comprises delivering newly generated content from the service provider using the cloud computing to designated storage which is managed by content delivery functions, and delivering content with controlled quality to terminal B using the content delivery functions.

14. The method of claim 1, wherein the continuously providing of the N-screen to terminal C comprises delivering same content with respect to the N-screen service based on the cloud computing to terminal C in motion using content delivery functions.

15. An apparatus for providing a service, comprising:
a service providing unit configured to provide an N-screen service to terminal A in motion;
a service request receiving unit configured to receive a request signal for the N-screen service from terminal B in motion;
a service preparing unit configured to prepare the N-screen service for terminal B;
a service control unit configured to provide the N-screen service to terminal B using cloud computing; and
a seamless service providing unit configured to provide the N-screen service to terminal C in motion.

16. The apparatus of claim 15, wherein the service providing unit provides the N-screen service to terminal A using the cloud computing.

17. The apparatus of claim 15, wherein the service providing unit provides the N-screen service to terminal A through content delivery functions.

18. The apparatus of claim 17, wherein in response to a request of terminal A for an additional service related to the content, the service providing unit supports or provides the additional service using the cloud computing.

19. The apparatus of claim 15, wherein in a case of handover to terminal A, the service providing unit provides new channel access information to terminal A for continuity of the N-screen service.

20. The apparatus of claim 17, wherein when an error is detected in network functions of a network provider that provides the N-screen service to terminal A, the service providing unit moves IT resources to another location to resolve the error.
